(19) United States
(12) Patent Application Publication
(10) Pub. No.: US 2023/0033142 A1
(43) Pub. Date: Feb. 2, 2023

(54) AEROLOGICAL SONDE

(71) Applicant: HURRICANE UNWINDER OY AB, Helsinki (FI)

(72) Inventors: Svante HENRIKSSON, Helsinki (FI); Antti PASILA, Helsinki (FI); Kim KAISTI, Helsinki (FI)

(21) Appl. No.: 17/777,640

(22) PCT Filed: Nov. 19, 2020
(86) PCT No.: PCT/FI2020/050778

§ 371 Date: May 18, 2022

(30) Foreign Application Priority Data
Nov. 20, 2019 (FI) 20195995

(51) Int. Cl. G01W 1/08

(52) U.S. Cl. CPC G01W 1/08

(57) ABSTRACT

An aerological sonde for measuring meteorological conditions in the atmosphere. The aerological sonde includes a sonde casing having an outer casing surface and a measurement unit arranged inside the sonde casing. The outer casing surface of the sonde casing is arranged to form a sole drag surface of the aerological sonde such that a self-sustaining aerological sonde is formed.

### FIELD OF THE INVENTION

The present invention relates to an aerological sonde and more particularly to an aerological sonde according to preamble of claim 1.

### BACKGROUND OF THE INVENTION

Meteorological conditions off ground in the atmosphere are conventionally measured with aerological sondes. The aerological sondes usually contain a GPS receiver, along with pressure, temperature, and humidity sensors to capture atmospheric profiles. The sondes typically transmit this data to a computer by radio transmission. This helps meteorologists to find out information at elevated heights, including in tropical cyclones and tornadoes. The data obtained is usually fed into computers for numerical weather prediction, enabling more accurate weather predictions.

There are basically two types of aerological sondes that work without being onboard powered vehicles, such as airplanes or drones. A dropsonde comprises a sonde device 2 and a parachute 6 attached to the sonde device 2 with an attachment member 7, as shown in FIG. 2. The dropsonde is dropped from an aircraft to measure storm conditions as the sonde device falls to the surface. The dropsonde descent is slowed and stabilized by the parachute, allowing for more readings to be taken before it reaches the ocean surface or ground surface. The parachute is designed to immediately deploy after release of the dropsonde for reducing or eliminating any pendulum movements. The dropsonde typically drops for three to fifteen minutes before reaching the ocean or ground surface. The dropsonde has a sonde casing to protect electronics and form a more stable aerodynamic profile. The parachute is attached to the sonde casing.

The other type of aerological sonde without a powered carrying airborn vehicle is a floating sonde comprising a sonde device 2 and a balloon 4 attached to the sonde device 2 with an attachment member 5, as shown in FIG. 1. The balloon is filled with gas lighter than air such that the flowing sonde raises upwards when released from the sea or ground surface. The balloon controls the ascent and stabilizes it. Some floating sondes are anchored to ground in such a way that they remain at a certain height. The floating sonde has a sonde casing to protect electronics and form a more stable aerodynamic profile. The balloon is attached to the sonde casing.

The prior art aerological sondes provide measurement information of meteorological conditions in their typically descending or ascending trajectory. Thus, the dropsonde provides measurement data during the time it falls through the air, for example through a cyclonic storm, and the floating radiosonde during the time it ascends, until it bursts or floats at a high level due to low environmental air pressure. Therefore, the disadvantage of the prior art aerological sondes is that the measurement results they provide have limited spatial and temporal extent while they systematically move in the vertical direction for a limited time.

### BRIEF DESCRIPTION OF THE INVENTION

An object of the present invention is to provide an aerological sonde so as to overcome or at least alleviate the prior art disadvantages. The objects of the invention are achieved by an aerological sonde which is characterized by what is stated in the independent claim 1.

The preferred embodiments of the invention are disclosed in the dependent claims.

The invention is based on the idea of providing an aerological sonde for measuring meteorological conditions in atmosphere, a cyclonic storm or a tornado or other atmospheric flows where both the vertical and horizontal dimensions of the atmosphere are of interest. The aerological sonde comprises a sonde casing having an outer casing surface and a measurement unit arranged inside the sonde casing. The outer casing surface of the sonde casing is arranged to form a drag surface of the aerological sonde such that a self-sustaining aerological sonde is formed.

In some embodiments, of the present invention, the whole drag surface of the aerological sonde is formed by the outer surface of the sonde alone. Thus, the outer casing surface of the sonde casing is arranged to form a sole drag surface of the aerological sonde such that the self-sustaining aerological sonde is formed. Accordingly, the aerological sonde does not comprise any external additional lift members, such as a balloon, increasing lift force of the aerological sonde or any external additional drag member increasing drag force of the aerological sonde, such as parachute. Thus, the aerological sonde of the present invention travels freely in atmospheric flows. This means, that winds may move and affect movements of the self-sustaining aerological sonde freely without stabilizing forces affecting the aerological sonde.

It should be noted that some components of the measurement unit may be provided on or extend outwards from the outer casing surface of the sonde casing. These components may comprise for example an antenna or a measurement head or tip of a sensor of the measurement unit. These measurement unit components extending or provided on the outer casing surface are minor components and have minor effect of the overall drag surface. Accordingly, in the context of this application the definition that the outer casing surface of the sonde casing is arranged to form drag surface of the aerological sonde means that some minor measurement unit components may extend of the outer casing surface. Thus, the drag surface is formed by the outer casing surface and one or more possible measurement unit components or parts thereof.

In an embodiment, in which the outer casing surface forms the sole drag surface of the self-sustaining aerological sonde, there are no measurement unit components on the outer casing surface.

The drag force affecting the aerological sonde is directly proportional to aerological sonde's projected surface area, which it encounters in the air during movement, with some corrections for Reynolds number. By the projected surface area is here meant the projected area in the direction of the movement.

In the self-sustaining aerological sonde, the drag surface, which comprises its whole external surface, consists of the outer surface of the sonde casing.

Alternatively, in the self-sustaining aerological sonde, the drag surface of the aerological sonde consists of the outer surface of the sonde casing and a component or part a component of the measurement unit.

The self-sustaining sonde is arranged to migrate in the atmosphere without any additional lift or drag member. The self-sustaining aerological sonde of the present invention has a terminal velocity which enables the self-sustaining aerological sonde stay in the atmosphere a prolonged time. The terminal velocity is determined by the outer casing surface of the self-sustaining aerological sonde and weight of the self-sustaining aerological sonde. The self-sustaining aerological sonde of the present invention has the terminal velocity equal to or less than 7 m/s.

In a preferred embodiment, the self-sustaining aerological sonde of the present invention has the terminal velocity equal to or less than 5 m/s.

In a more preferable embodiment, the self-sustaining aerological sonde of the present invention has the terminal velocity equal to or less than 4 m/s.

The smaller the terminal velocity is, the longer the self-sustaining aerological sonde may migrate in the atmosphere.

In one embodiment, the self-sustaining aerological sonde has a terminal velocity equal to or less than 3 m/s in standard atmospheric conditions.

Standard atmospheric conditions are defined as a temperature of 273.15 K and a pressure of 100 kPa. From here on, when discussing the terminal velocity of the aerological sonde, the terminal velocity in standard atmospheric conditions is meant. The terminal velocity of the self-sustaining sonde is determined by the outer casing surface of the sonde casing and the weight of the self-sustaining aerological sonde, with some corrections for Reynolds number. When a cyclonic storm or other meteorological phenomena comprises an upward vertical wind component which is equal or greater than the terminal velocity of the self-sustaining aerological sonde, it self-sustaining maintains its altitude or rises upwards. In cyclonic storms, that are envisioned as one of the main measurement targets of the self-sustaining sonde, upward vertical wind components which are substantially 3 m/s or greater may occur in the eyewall region. Even when the upward vertical wind component is less than 3 m/s, it is often of the order of 1 m/s or higher, considerably slowing down the descent of the aerological sonde. Therefore, the self-sustaining aerological sonde may float or migrate in a cyclonic storm for prolonged time periods and considerable distances, hence improving on prior art.

In one embodiment, the sonde casing is made of a material having a material density equal to or less than 0.2 g/cm³. Light and durable materials are preferable, as the weight of the self-sustaining aerological sonde has a direct effect on the terminal velocity of the self-sustaining aerological sonde.

In another embodiment, the sonde casing is made of a material having a material density equal to or less than 0.15 g/cm³. Materials with smaller density are preferable as the wall of the sonde casing may be provided necessary thickness as the material density is low.

In a further embodiment, the sonde casing is made of a material having a material density equal to or less than 0.1 g/cm³. With the sonde casing having a material density 0.1 g/cm³ or lower, the weight of the sonde casing may be provided low enough so as to reach terminal velocity of 3 m/s or less for the self-sustaining aerological sonde.

In one embodiment, the sonde casing is made out of aerogel material. Aerogel materials are light-weight with material density of less than 0.15 g/cm³ or less than 0.1 g/cm³. Many aerogel materials are further electrically non-conductive and weather proof, meaning that aerogel materials are humidity and/or water proof or humidity and/or water resistant.

In another embodiment, the sonde casing is made out of foam material. Foam materials are light-weight, many of which have a material density of less than 0.1 g/cm³. Foam materials are also durable and easy to work. Many foam materials are further electrically non-conductive and weather proof, meaning that they are humidity and/or water proof or humidity and/or water resistant. Further, many foam materials provide good thermal insulation.

In one embodiment, the sonde casing is made of polystyrene, which is a foam material. One preferable material is extruded polystyrene which having closed cell structure providing high material strength, electrically non-conductive characteristics and good thermal insulation. Extruded polystyrene has a material density of less than 0.05 g/cm³. One such material is called Finnfoam®, having material density about less than 0.05 g/cm³.

In one embodiment, the weight of the sonde casing is equal to or less than 2.5 g. This together with the low-density material enables providing the self-sustaining aerological sonde with terminal velocity of 3 m/s or less.

In one embodiment, the outer casing surface of the sonde casing is arranged to define shape of the aerological sonde having drag coefficient equal to or greater than 0.4 for Reynolds number 10⁴. The drag coefficient effects terminal velocity. The greater the drag coefficient, the lower the terminal velocity. The drag coefficient is specific for the shape of the self-sustaining aerological sonde, given a certain Reynolds number. Thus, in order to provide a terminal velocity of 3 m/s or less for the self-sustaining aerological sonde, the shape of the sonde casing is formed such that a high drag coefficient is achieved.

Accordingly, in the present invention the self-sustaining aerological sonde is provided with high-drag aerodynamic properties such that low terminal velocity of the self-sustaining aerological sonde is achieved.

In one embodiment, the self-sustaining aerological sonde comprises a spherical or elliptical shape defined by the outer casing surface of the sonde casing.

The drag coefficient of the spherical sonde casing is 0.47 for Reynolds number 10⁴. A sphere is a preferable shape as it is a vast body of literature of exists for its aerodynamic properties for Reynolds numbers, which makes the following inversion calculations from position as a function of time information to velocity easier.

In another embodiment, the self-sustaining aerological sonde comprises a cubical shape defined by the outer casing surface of the sonde casing. The drag coefficient of a cubical sonde casing is 0.8-1.05, depending on its alignment in relation to its direction of movement, for Reynolds number 10⁴. The cube is also preferable shape as it is a symmetrical shape and inversion calculations from position as a function of time to velocity can still be made with reasonable ease. Further, the cubical shape enables attaching the measurement unit or components thereof to the planar walls of the cubical sonde casing.

In a further embodiment, the self-sustaining aerological sonde has a cubical shape with rounded corners defined by the outer casing surface of the sonde casing. The drag coefficient of the rounded cube sonde casing is less than 1.05 for Reynolds number 10⁴. The rounded cube also provides a symmetrical shape and potential for simple inversion calculations, as for the sphere and cube above. Further, the rounded cube shape enables attaching measurement unit or components thereof to the planar walls of the rounded cube sonde casing. The rounded corners decrease the amount of material in the sonde casing and lower the weight of the sonde casing.

In a yet other embodiment, the self-sustaining aerological sonde comprises a polyhedron shape or regular polyhedron shape defined by the outer casing surface of the sonde casing. Further, the polyhedron shape enables attaching measurement unit or components thereof to the planar walls of the polyhedron sonde casing.

In one embodiment, the sonde casing comprises a first symmetry plane and a second symmetry plane. The first symmetry plane and the second symmetry plane extending perpendicularly to each other. The symmetry in relation to the two symmetry planes provides a simple sonde casing which is easy to manufacture.

In another embodiment, the sonde casing comprises a first symmetry plane, a second symmetry plane and a third symmetry plane. The first symmetry plane, the second symmetry plane and the third symmetry plane extend perpendicularly to each other. The symmetry in relation to the three symmetry planes provides a simple sonde casing which is easy to manufacture. Further, this symmetry provides balanced aerodynamical properties for the self-sustaining aerological sonde enabling accurate calculations of the movement and behaviour of the self-sustaining aerological sonde in the cyclonic storm.

In one embodiment, the measurement unit comprises a printed circuit board.

In another embodiment, the measurement unit comprises a printed circuit board, and the printed circuit board is a flexible printed circuit board. A flexible printed circuit board is light-weight and has good thermal properties.

In one embodiment, the self-sustaining aerological sonde comprises a support structure for the flexible printed board. The flexible printed circuit board is supported on the support structure. The support structure provides mechanical stability for the flexible printed circuit board and alleviates securing the flexible printed circuit board to the sonde casing.

In one embodiment, the support structure is made of material having honeycomb structure, the support structure is made of aerogel material, paper-based material or the support structure is made of foam material, such as polystyrene. These materials provide mechanical and structural rigidity and support for the flexible printed circuit board and have low material density, as disclosed above.

In one embodiment, the flexible printed circuit board is supported on or to inner surface of the sonde casing. This is a preferable construction as there is no need for additional support structure for the flexible circuit board. The flexible printed circuit board may be supported on or to the inner surface of the sonde casing as the sonde casing comprises planar surfaces as in cubic or polyhedron shapes.

In one embodiment, the measurement unit comprises a global navigation satellite system (GNSS) antenna provided to the circuit board or to the flexible printed circuit board as a circuit board antenna. Providing the GNSS antenna as the circuit board antenna enables utilizing light-weight antenna solutions and additional cables and connectors between the circuit board and the GNSS antenna may be omitted in such a way that the weight of the measurement unit may be reduced.

In another embodiment, the measurement unit comprises a frequency modulation (FM) antenna provided to the circuit board or to the flexible circuit board as circuit board antenna. Also, in this case, additional cables and connectors between the circuit board and the FM antenna may be omitted so that the weight of the measurement unit may be reduced.

In a further embodiment, the measurement unit comprises a global navigation satellite system antenna and a frequency modulation antenna provided to the circuit board or to the flexible circuit board as circuit board antennas.

In one embodiment, the measurement unit comprises a battery having weight equal to or less than 2 g. The battery is the heaviest component in the measurement unit. Thus, a battery having weight 2 g or less is essential for achieving a terminal velocity of 7 m/s or under, or 5 m/s or under.

In one embodiment, the outer casing surface of the sonde casing comprises one or more protrusions protruding outwards from the outer casing surface of the sonde casing increasing the drag coefficient. The protrusions increase the drag force subjected to the self-sustaining aerological sonde without considerably increasing the weight of the sonde casing.

The protrusions are preferably made of the same material as the sonde casing.

In one embodiment, the sonde casing comprises two or more openings provided to the sonde casing, the two or more openings extending through the casing walls of the sonde casing for enabling air flow inside the sonde casing.

The openings enable air flow inside the sonde casing and also through the sonde casing which further increases draft force subjected to aerological sonde.

In one embodiment, the total weight of the self-sustaining aerological sonde is equal to or less than 8 g, or preferably equal to or less than 6 g, or more preferably 5 g or less. These weight limits enable providing a substantially small sonde casing such that the terminal velocity of 7 m/s or less, or 5 m/s or less, or 4 m/s or less, may be achieved. Increasing the size or dimensions of the sonde casing causes the material weight of the sonde casing to increase

An advantage of the invention is that the present invention provides an aerological sonde which may float or migrate freely in and along the cyclonic storm or in other meteorological conditions as self-sustaining, while only descending slowly or in some cases not at all. Thus, the self-sustaining aerological sonde is capable of carrying out measurements in the cyclonic storm for prolonged times and achieving great amounts of data that can be applied providing accurate forecasts. Further, the self-sustaining aerological sonde may move within a cyclonic storm or in other meteorological conditions and in air flows therein, and this enables measuring turbulence and turbulent flows.

### BRIEF DESCRIPTION OF THE DRAWINGS

The invention is described in detail by means of specific embodiments with reference to the enclosed drawings, in which

FIGS. 1 and 2 show schematically prior art aerological sondes without carrying airborne vehicles;

FIGS. 3 to 11 show different embodiments of a cubical aerological sonde according to the present invention;

FIGS. 12 to 16 show different embodiments of a spherical aerological sonde according to the present invention;

FIGS. 17 to 20 show schematically effective surface areas of different shapes of the aerological sonde according to the present invention in relation to drag coefficient;

FIG. 21 shows schematically one embodiment of a measurement unit of the aerological sonde according to the present invention;

FIG. 22 shows schematically one embodiment of a meterorological measurement element of the aerological sonde according to the present invention;

FIGS. 23-25 show schematically one embodiment of a movement sensor element of the aerological sonde according to the present invention; and

FIGS. 26 and 27 show schematically embodiments of a sonde casing of the aerological sonde according to the present invention.

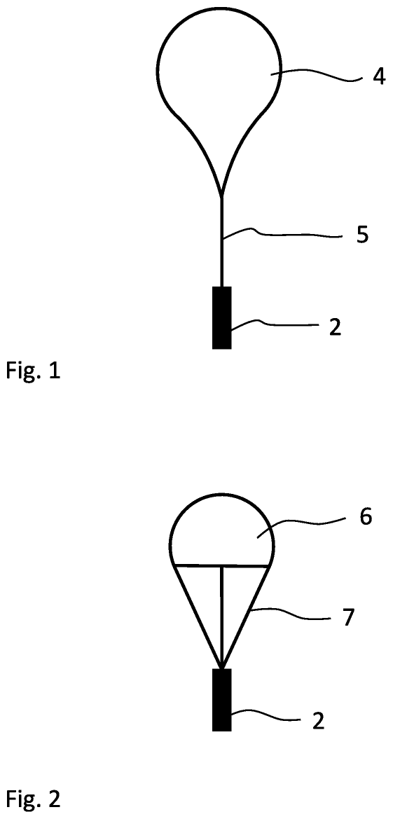

### DETAILED DESCRIPTION OF THE INVENTION

In the context of this application, the aerological sonde 10, and all the parts and components thereof, means an aerological sonde which is arranged to be floated or migrated in in atmosphere and atmospheric flows, for example in a cyclonic storm.

In the context of this application, a cyclonic storm means a rapidly rotating storm system comprising a low-pressure center, a closed low-level atmospheric circulation, strong winds, and a spiral arrangement of thunderstorms. Depending on its location and strength, the cyclonic storm is referred to by different names, including hurricane, typhoon, tropical storm, tropical depression, and simply cyclone. Further a tornado is a rapidly rotating column of air that is in contact with both the surface of the Earth and a cumulonimbus cloud. A tornado is often referred to as a twister, whirlwind or cyclone.

In the context of this application, the aerological sonde according to the present invention comprises sonde casing and a measurement unit inside the sonde casing. The measurement unit comprises components for carrying out measurements relating to meteorological conditions of the cyclonic storm. The sonde casing comprises casing walls having an outer surface and this outer surface of the sonde casing also forms the outer surface of the aerological sonde. Therefore, the outer surface of the sonde casing alone defines outer shape of the aerological sonde. This means, that there are no additional components provided outside the sonde casing or the casing walls. Thus, the sonde casing and the outer surface of the sonde casing is arranged to define sole drag surface of the whole aerological sonde. Thus, a self-sustaining aerological sonde may be provided.

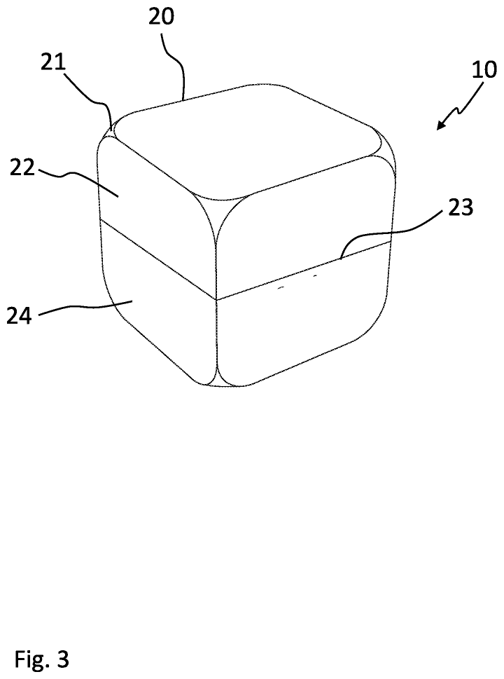

Different embodiments of a self-sustaining aerological sonde 10 according to the present invention is shown in FIGS. 3 to 27.

In some embodiments, the outer casing surface forms the sole outer surface of the aerological sonde. Accordingly, the outer casing surface forms the only, and thus sole, drag surface of the aerological sonde as it migrates in the atmosphere. Accordingly, in this embodiment there are no other components or elements provided on or extending outwards from the outer casing surface.

In some other embodiments, one or more components of the measurement unit may be provided on or extend outwards from the outer casing surface of the sonde casing. These components may comprise for example antenna or measurement head or tip of a sensor of the measurement unit. These measurement unit components extending or provided on the outer casing surface are minor components and have minor effect of the overall drag surface.

Accordingly, in the context of this application, the drag surface is formed by the outer casing surface and one or more possible measurement unit components or parts thereof.

In an embodiment, in which the outer casing surface forms the sole drag surface of the self-sustaining aerological sonde, there are no measurement unit components on the outer casing surface.

Terminal velocity is a maximum velocity attainable by an object as it falls through a fluid or a gas, for example air. It occurs when the sum of the drag force subjected to the object and the buoyancy subjected to the object is equal to the downward force of gravity acting on the object. Since the net force on the object is zero, the object has zero acceleration. Thus, the object is moving at its terminal velocity if its speed is constant due to the restraining force exerted by the gas through which it is moving. As the speed of the object increases, so does the drag force acting on it. At some speed, the drag force will equal to the gravitational pull on the object. At this point the object ceases to accelerate and continues falling at a constant speed called the terminal velocity. The drag force depends on the projected area or cross-sectional area or silhouette area of the object in a horizontal plane.

Drag force is calculated from an equation:

F_{D}=½ρυ²C_{D}A

, where

F_{D}=drag force,

ρ=density of the fluid (air 1.225),

υ=speed of object relative to the fluid,

C_{D}=drag coefficient of the object, and

A=cross-sectional area of the object.

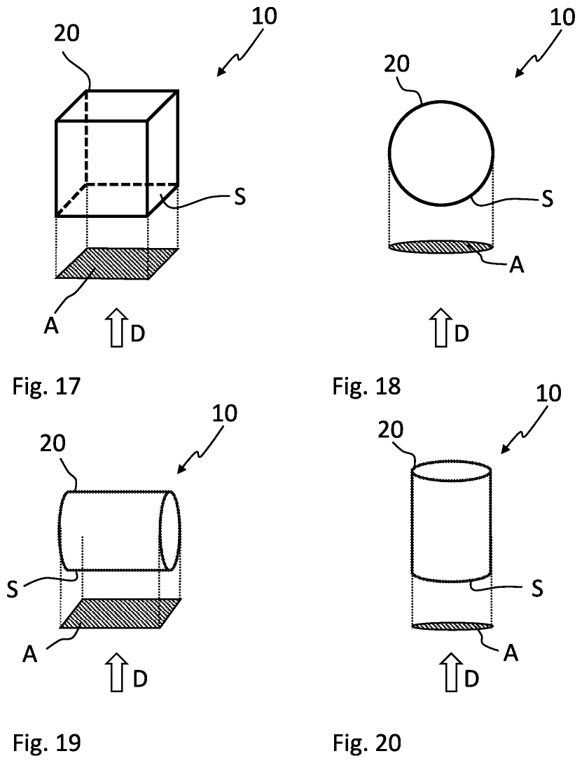

FIGS. 17, 18, 19 and 20 show aerological sondes 10 with different shapes. The shape of the aerological sondes 10 is defined by the outer surface S of the sonde casing 20. Therefore, sonde casing 20 and the outer surface S thereof defines the shape of the aerological sonde 10 and also the projected area or cross-sectional area A of the aerological sonde 10. The projected area A of the aerological sonde 10 depends on the projection direction D, as shown in FIGS. 19 and 20. In FIGS. 19 and 20 two different projected areas A are shown for an aerological sonde 10 having cylindrical shape as viewed in direction D. Further, the projected area of an aerological sonde 10 having spherical shape, shown in FIG. 18, is same in all directions D as the cross-sectional area is the same in all viewing directions D and the sphere is symmetrical in relation to its centre point. The sphere is also symmetrical in relation to three symmetry planes extending perpendicularly to each other. The aerological sonde 10 having cubic shape, as shown in FIG. 17, is also symmetrical in relation to three symmetry planes extending perpendicularly to each other. However, the cross-sectional area A of the cubic shape varies depending on the viewing direction D.

The shape of the aerological object further has an effect on the drag coefficient. The drag coefficient if specific for a certain shape. Thus, every shape has a different drag coefficient, that is further dependent on the Reynolds number. The smaller the drag coefficient the smaller the drag force.

In the context of this application, the aerological sonde and the sonde casing thereof is provided with a shape having good drag properties. Thus, the shape of the aerological sonde and the sonde casing is provided such that a relatively high drag coefficient is achieved. In the present invention of the drag coefficient of the aerological sonde and the sonde casing is equal to or greater than 0.4, with Reynolds number 10⁴. The Reynolds number changes due to velocity in respect to the object in the fluid, such as the aerological sonde in air. The concept of Reynold number is generally known.

The drag coefficient for example a sphere is 0.47, for a cube 0.8-1.05 (depending on alignment), for a cone about 0.5 (depending on alignment) and for a short cylinder about 1.15 (depending on alignment), with Reynolds number 10⁴. It should be noted, that the drag coefficient for a streamlined shape may be 0.05 or less, with Reynolds number 10⁴.

Accordingly, in the present invention the shape of the aerological sonde defined by the outer surface of the sonde casing is greater than 0.4, with Reynolds number 10⁴. To achieve this, the shape of the sonde casing is spherical, elliptical, cubical, conical, cylindrical, polyhedral or the like having drag coefficient equal to or greater than 0.4. The sonde casing may also have cubical, conical, cylindrical or polyhedral shape with rounded corners.

Symmetrical shapes are preferable for calculating turbulence values of the cyclonic storm based on the behaviour and movement and angular velocities and changing translation and velocities and angular velocities. Compared to asymmetric shapes, movement behaviour of symmetrical shapes is easier to model and estimate, and their behaviour in turbulent flows may be calculated more easily. However, the present invention is not restricted to any specific shape, symmetrical shape or non-symmetrical shape.

According to the above mentioned, in preferred embodiments the sonde casing 20 of the self-sustaining aerological sonde comprises a first symmetry plane B and a second symmetry plane C. The first symmetry plane B and the second symmetry plane C extend perpendicularly to each other. Thus, the sonde casing may have a cubical, cylindrical, polyhedral, spherical or elliptical shape with the first and second symmetry planes B, C.

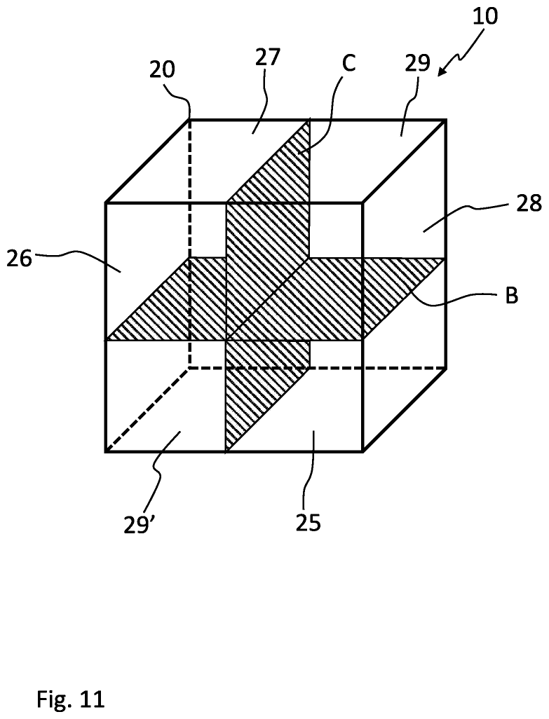

FIG. 11 shows an embodiment in which the sonde casing 20 comprises a shape with the first and second symmetry planes C, D. The first symmetry plane B extends between a first side wall 26 and a second wall 28 of the sonde casing 20 and between a third side wall 29 and a fourth side wall 29′, and in horizontal direction in FIG. 11. Further, the second symmetry plane C extends between a top wall 27 and a bottom wall 25 of the sonde casing 20 and between the third side wall 29 and the fourth side wall 29′ and in vertical direction in FIG. 11.

In the cubical shape of the sonde casing 20 of the embodiment of FIG. 11 further comprises a third symmetry plane (not shown) extending between the first side wall 26 and a second wall 28 of the sonde casing 20 and between the top wall 27 and the bottom wall 25 of the sonde casing 20 and in vertical direction in FIG. 11. The third symmetry plane extends perpendicularly to the first and second symmetry planes B, C.

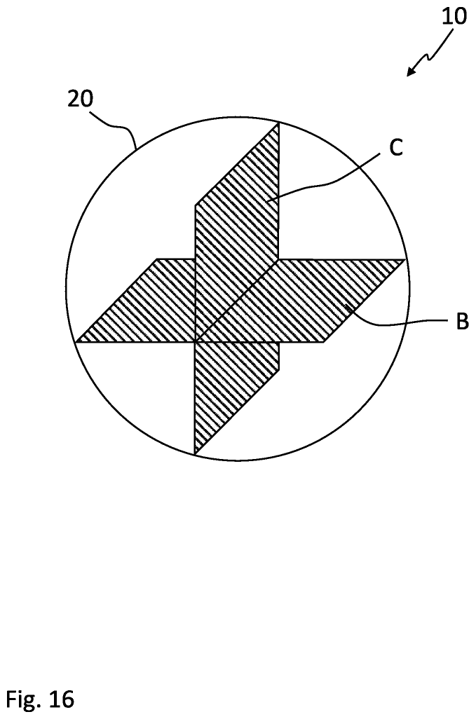

FIG. 16 shows another embodiment in which the sonde casing 20 comprises a spherical shape with the first and second symmetry planes C, D. The first and second symmetry planes C, D are perpendicular to each other. Also in this embodiment, the sonde casing 20 comprises third symmetry plane (not shown) extending perpendicularly to the first and second symmetry planes B, C.

It should be noted, that the sonde casing 20 may have shape comprising only one or two symmetry planes.

The self-sustaining aerological sonde 10 has a centre of gravity defined by the sonde casing and the measurement unit and the components of the measurement unit. In some embodiments, the centre of gravity is arranged on at least one of the symmetry planes B, C of the sonde casing. In other preferable embodiments, the centre of gravity is arranged on at least two of the symmetry planes B, C and in their intersection. In more preferable embodiments, the centre of gravity is arranged to intersection of three symmetry planes B, C of the sonde casing 20.

In the present application, the object is to provide the terminal velocity of the aerological sonde as small as possible so that the aerological sonde may float or drift along a cyclonic storm or in other meteorological conditions or turbulent flows in atmosphere as long as possible and the descent of the aerological sonde is as slow as possible. The smaller the terminal velocity is, the longer the aerological sonde can float around. In a cyclonic storm, there is usually updrafts and upward vertical flows greater than the terminal velocity of the aerological sonde may occur often if the terminal velocity of the aerological sonde is low. In these situations, the aerological sonde will actually ascend rather than descend, at least momentarily.

The terminal velocity of a shape is calculated with equation:

$${v}_{t} = \sqrt{\frac{2 m g}{ρ A {C}_{D}}}$$

where

m=mass of the object,

g=gravity (9.81 m/s²),

ρ=density of the fluid (air 1.225),

A=projected or cross-sectional area of the object, and

C_{D}=drag coefficient of the object.

With Reynolds number given, there are basically two elements affecting the terminal velocity of the aerological sonde which may be controlled: mass or weight of the aerological sonde and the cross-sectional area or size and shape of the aerological sonde. By selecting a shape with a high drag coefficient the terminal velocity of the aerological sonde may be decreased. Increasing the size of the aerological sonde reduces the terminal velocity, but at the same time weight of the aerological sonde or the sonde casing 20 is increased.

In the present invention, the self-sustaining aerological sonde 10 has the terminal velocity equal to or less than 7 m/s, or preferably equal to or less than 5 m/s, or more preferably equal to or less than 4 m/s in standard atmospheric conditions. As disclosed above, the terminal velocity of the self-sustaining sonde is determined by the outer casing surface of the sonde casing, or the shape of the aerological sonde, and the weight of the self-sustaining aerological sonde. When the cyclonic storm comprises a vertical wind component or storm which is equal or greater than the terminal velocity of the self-sustaining aerological sonde, the self-sustaining aerological sonde maintains its altitude or raises upwards. In cyclonic storms, there are at times vertical wind components on the order of 3 m/s or greater. Also, in tornados such vertical wind components occur. Therefore, the self-sustaining aerological sonde may float or migrate in a cyclonic storm or tornado and along with the storm for prolonged time periods and considerable distances. When the self-sustaining aerological sonde has a terminal velocity of 7 m/s or less, or 5 m/s or less, or 4 m/s or less, the self-sustaining aerological sonde may float in the cyclonic storm or a tornado for a prolonged time. However, when the terminal velocity of the aerological sonde is 7 m/s or less, or 5 m/s or less, or 4 m/s or less, it is likely that the cyclonic storm or the tornado comprises vertical wind components or streams enabling the self-sustaining aerological sonde float along the cyclonic storm or the tornado for prolonged time with very small or non-existing descent, as cyclonic storms or tornadoes at times have updrafts or vertically upwards flows equal to or greater than 3 m/s.

It is especially advantageous, when the terminal velocity of the aerological sonde is equal to 5 m/s or less as in cyclonic storms or atmospheric winds the updrafts or vertically upwards flows of 5 m/s or less are more common than considerably higher flow velocities.

In order to achieve the above mentioned terminal velocity, total weight of the self-sustaining aerological sonde 10 needs to be restricted in relating to the projected area. Increasing the size of the aerological sonde 10 would decrease the terminal velocity, but at the same time the weight of the aerological sonde would be increased due to the enlarged sonde casing 20. Therefore, the in order to achieve the above disclosed terminal velocity, the total weight of the aerological sonde 10 is equal to or less than 8 g, or preferably equal to or less than 6 g, or more preferably equal to or less than 5g. When the total weight of the aerological sonde 10 is substantially 6 g or less, the size of the aerological sonde 10 and the sonde casing 20 may be kept rather small and the above disclosed terminal velocity may be still achieved.

The present invention is not limited to any particular weight of the aerological sonde 10, but the weight is provided such that the desired terminal velocity is achieved, as disclosed above.

Substantially means that the total weight of the aerological sonde may very within +/−5% of the mentioned weight, for example g.

In order to achieve the total weight of 8 g or less, or 6 g or less, or 5 g or less, for the aerological sonde, the weight of the sonde casing 20 is 2.5 g or less. Preferably, the weight of the sonde casing 20 is substantially 2 g or less. The sonde casing 20 and the weight thereof consists of the casing walls and thus of the weight of the casing walls forming the outer surface of the sonde casing 20.

The present invention is not limited to any particular weight of the sonde casing 20, but the weight of the sonde casing is provided such that the desired terminal velocity is achieved, as disclosed above.

The sonde casing needs to have necessary mechanical strength and rigidity such that the measurement unit 12 and the components thereof are protected from damage and deterioration during the measurement time when the self-sustaining sonde 10 floats along the cyclonic storm, while slowly descending in many cases. Thus, the wall thickness of the sonde casing 20 needs to be thick enough to achieve the mechanical protection for the measurement unit 12 and thick enough for maintaining the shape of the sonde casing 20 under the forces of the cyclonic storm.

In some embodiments, the sonde casing 20 is made of material having material density equal to or less than 0.2 g/cm³.

In preferable embodiments, the sonde casing 20 is made of material having material density equal to or less than 0.15 g/cm³.

In more preferable embodiments, the sonde casing 20 is made of material having material density equal to or less than 0.1 g/cm³.

One preferable material or type of material for the sonde casing is aerogel material. Aerogel is a synthetic porous ultralight material derived from a gel, in which the liquid component for the gel has been replaced with a gas. Aerogels have a solid structure with extremely low density and extremely low thermal conductivity. Aerogels are good thermal insulators and provide good thermal insulation. Aerogels by themselves are hydrophilic, but may be provided as hydrophobic, via a chemical treatment. Thus, a hydrophobic layer may be provided on the outer surface and/or inner surface of the aerogel or the sonde casing 20 made of aerogel material. Aerogel materials have density 0.2 g/cm³ or less. Examples of aerogel materials are form example silica aerogels, carbon aerogels and metal oxide aerogels.

Another preferable material or type of material for the sonde casing is foam material having density according to above mentioned.

One preferable foam material is polystyrene foam material, and especially extruded polystyrene. Extruded polystyrene has a compact cell structure which provides high strength and good thermal insulation and moisture barrier. Extruded polystyrene has a very material density of about less than 0.05 g/cm³ which makes is well suitable material for the self-sustaining aerological sonde 10. One preferable extruded polystyrene is marketed under the name Finnfoam®.

FIG. 3 shows one embodiment of an aerological sonde 10 according to the present invention. The aerological sonde 10 comprises a sonde casing 20 forming the outer surface of the aerological sonde. Thus, the sonde casing 20 comprises the outer surface and the outer surface forms and provides the shape or outer shape of the aerological sonde 10.

In the embodiment of FIG. 3, the aerological sonde 10 and the outer surface of the sonde casing 20 provides a cubic shape. Accordingly, the aerological sonde 10 of FIG. 3 has cubic outer shape. Further, the corners 21 of the cubic shape are rounded such that the aerological sonde 10 has rounded cubic shape.

The sonde casing 20 comprises casing walls which defines a hollow sonde space inside the sonde casing. A measurement unit and measurement components are provided and installed inside the sonde casing 20 and into the sonde space.

The sonde casing 20 comprises two halves, a first half 22 and a second half 24, which are attached to each other along a connection line 23, as shown in FIG. 3. The sonde space inside the sonde casing 20 is defined by the two halves 22, 24. This makes manufacturing of the sonde casing 20 simpler and also facilitates installing the measurement unit and measurement components inside the sonde casing 20. The halves 22, 24 are attached or secured to each other along the connection line 23 for sealing the sonde space inside the sonde casing.

The aerological sonde 10 of FIG. 3 has a drag surface which is formed solely by the outer surface of the sonde casing 20.

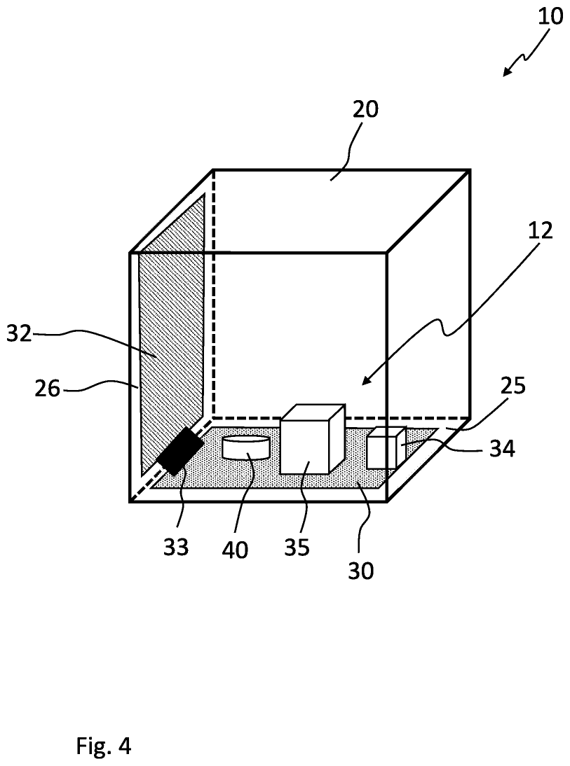

FIG. 4 shows schematically a one embodiment of the aerological sonde 10 having the sonde casing 20 and a measurement unit 12 arranged inside the sonde casing 20. The measurement unit 12 comprises a circuit board 30 or a printed circuit board 30 and measurement components provided to the printed circuit board 30 and in connection thereof.

The circuit board 30 may be one of the biggest components in the measurement unit 12. Thus, the circuit board has considerable effect on the weight of the measurement unit 12 and the aerological sonde 10.

A light-weight circuit board is preferable for the measurement unit 12.

In one embodiment, the circuit board 30 is a flexible circuit board 30.

The flexible circuit board 30 may be for example a flexible Polyimide circuit board.

The thickness of the flexible circuit board may be between 30 to 80 μm, for example 50 μm. Flexible circuit board 30 is very soft material and needs to be mechanically stabilized with a support.

In the embodiment of FIG. 4, the circuit board 30 is attached to the sonde casing 20, and especially to inner surface of the sonde casing 20 or casing walls. In the embodiment, of FIG. 4 the flexible circuit board is supported to the bottom wall 25, or inner surface thereof, of the sonde casing 20.

Securing or supporting the circuit board directly to the sonde casing 20 or a wall thereof may be utilized when sonde casing comprises at least one planar surface. Thus, the sonde casing 20 has a shape comprising at least one planar surface or wall and the circuit board 30 is attached to at least one planar surface or wall of the sonde casing 20. It should be noted, that the circuit board 30 may also be provided on two more separate walls or surfaces of the sonde casing 20.

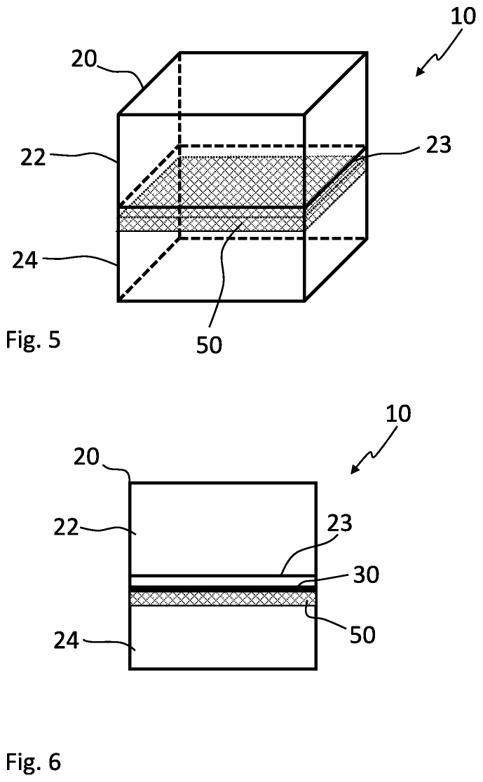

FIGS. 5, 6 and 7 show a different embodiment in which the self-sustaining aerological sonde is provided with a support structure 50. The support structure 50 is supported or secured to the sonde casing 20. As shown in FIGS. 5, 6 and 7, the support structure 50 is secured to the side walls of the sonde casing 20.

Further, the support structure 50 is secured to the second half 24 of the sonde casing. Thus, the connection line 23 between the first and second halves 22, 24 remains free. This makes manufacturing and assembling the aerological sonde 10 simple and effective.

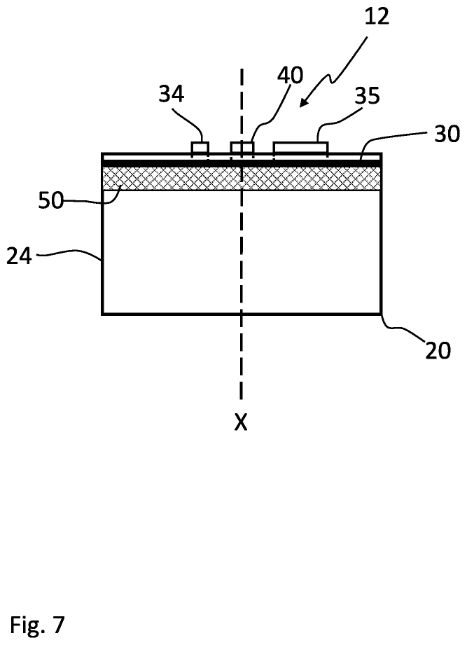

The circuit board 30 or the flexible circuit board 30 is further attached or supported to the support structure 50, as shown in FIGS. 6 and 7. Thus, the support structure 50 provides a support surface and mechanical support for the circuit board 30.

The support structure 50 is especially good for flexible circuit board 30. The flexible circuit board 30 is supported and secured to the support structure 50. Thus, the flexible circuit board 30 is mechanically supported and provided with necessary rigidity.

The support structure 50 increases the weight of the aerological sonde 10. However, the support structure 50 also enables arranging the measurement unit, the circuit board and the measurement components closer to the centre point of the sonde casing 20. Thus, the centre of gravity of the aerological sonde 10 may be provided close to the geometrical centre point of the sonde casing 20. This enhances balancing the aerological sonde 10 for accurate movement measurements.

In some embodiments, the support structure 50 is made of same material as the sonde casing 20.

In some embodiment, the support structure 50 is made of aerogel material, paper-based material or foam material, such as extruded polystyrene. Further, in some embodiments, the support structure 50 is made of material having honeycomb or porous structure.

The support structure is preferably made of light-weight material for keeping the total weight of the aerological sonde 10 low.

In some embodiments, the support structure 50 is made of material having material density equal to or less than 0.2 g/cm³, preferably equal to or less than 0.15 g/cm³.

In more preferable embodiments, the support structure 50 is made of material having material density equal to or less than 0.1 g/cm³.

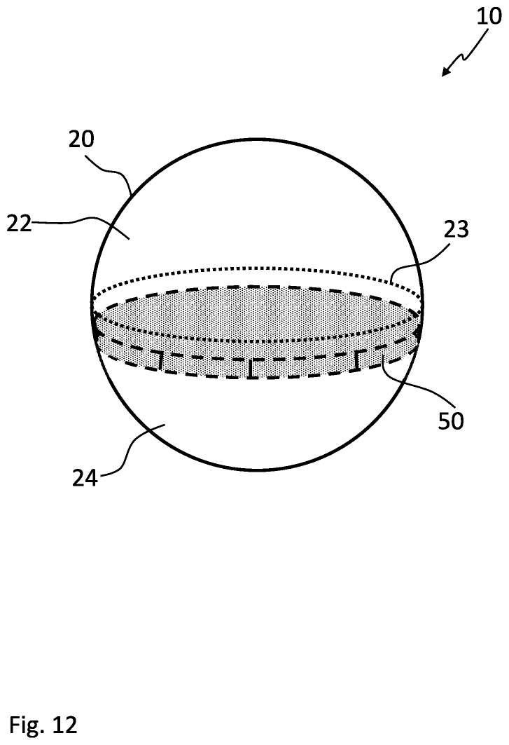

FIGS. 12, 13 and 14 show similar embodiments as described above, but the sonde casing 20 is spherical sonde casing 20. The support structure 50 is supported or secured to the sonde casing 20. As shown in FIGS. 12, 13 and 14, the support structure 50 is secured to the inner surface of the spherical sonde casing 20.

Further, the support structure 50 is secured to the second half 24 of the spherical sonde casing 20. Thus, the connection line 23 between the first and second halves 22, 24 remains free. This makes manufacturing and assembling the aerological sonde 10 simple and effective.

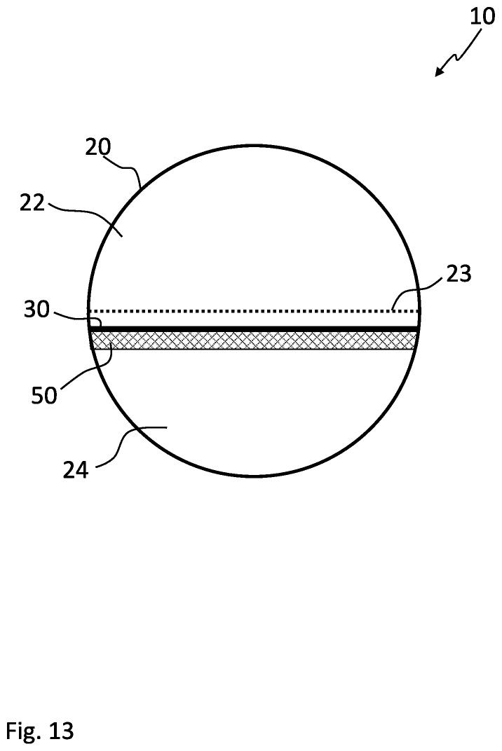

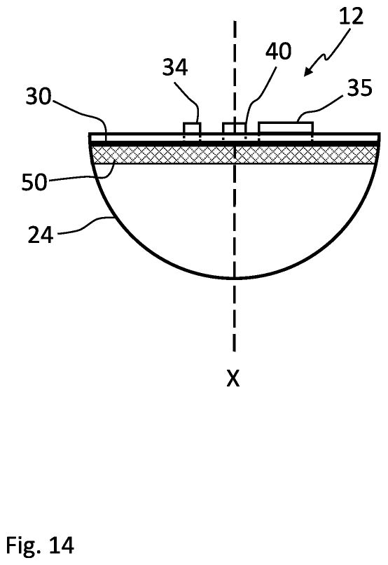

The circuit board 30 or the flexible circuit board 30 is further attached or supported to the support structure 50, as shown in FIGS. 13 and 14. Thus, the support structure 50 provides support surface and mechanical support for the circuit board 30.

The support structure 50 is particularly good a for flexible circuit board 30. The flexible circuit board 30 is supported and secured to the support structure 50. Thus, the flexible circuit board 30 is mechanically supported and provided with necessary rigidity.

The centre of gravity of the aerological sonde 10 may be provided close to the geometrical centre point of the spherical sonde casing 20 by utilizing the support structure 50 and placing the circuit board 30 on the support structure 50.

In some embodiments, the sonde casing 20 may also comprise reinforcement members.

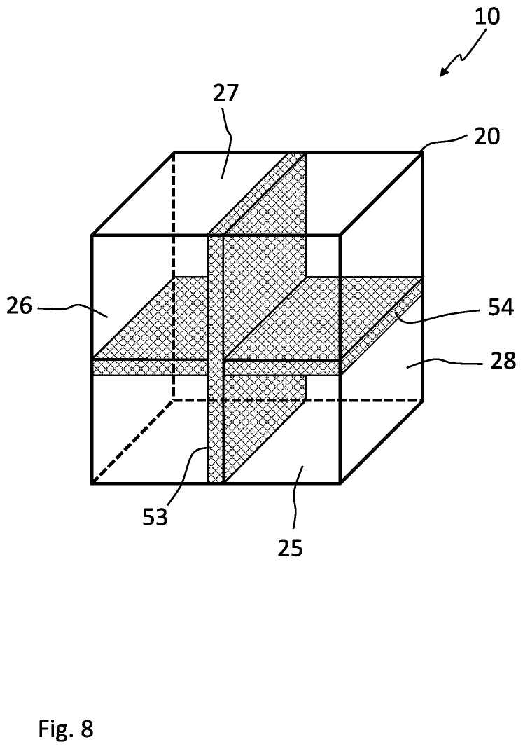

One embodiment of the structural reinforcement members 53, 54 is shown in FIG. 8. In FIG. 8, the sonde casing 20 comprises a first reinforcement member 54 extends between the first side wall 26 and the second wall 28 of the sonde casing 20 and between the third side wall 29 and the fourth side wall 29′, and in horizontal direction in FIG. 8. Further, the second reinforcement member 53 extends between the top wall 27 and the bottom wall 25 of the sonde casing 20 and between the third side wall 29 and the fourth side wall 29′ and in vertical direction in FIG. 8. The first and second reinforcement members or plates 54, 53 extend perpendicularly to each other.

There could also be a third reinforcement member (not shown) extending between the first side wall 26 and the second wall 28 of the sonde casing 20 and between the top wall 27 and the bottom wall 25 of the sonde casing 20 and in vertical direction in FIG. 8. The third symmetry plane extends perpendicularly to the first and second reinforcement members 54, 53.

The reinforcement members or plates 54, 53 may be arranged to locations of the symmetry planes, as in FIG. 11. In FIG. 8, the reinforcement members 54, 53 are provided as reinforcement plates.

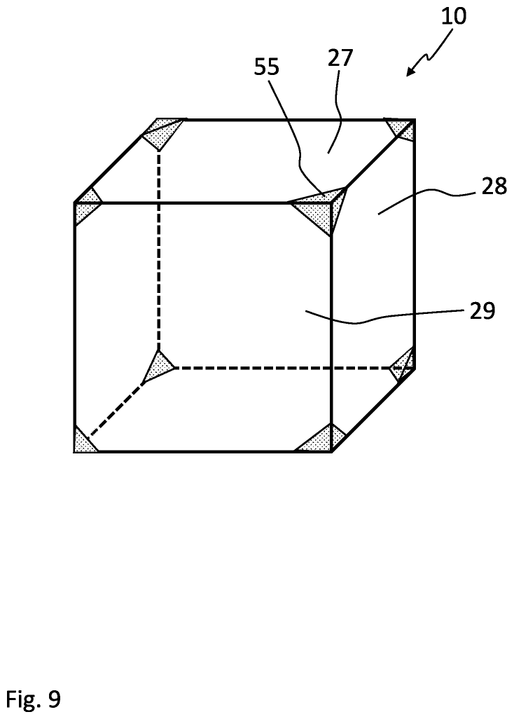

FIG. 9 shows another embodiment in which reinforcement members 55 are provided to corners of the cubical sonde casing 20. The reinforcements members 55 are provided as triangles provided to the corners and extending on the adjacent casing walls 27, 28, 29 from the corners. This provides mechanical strength to the sonde casing 20.

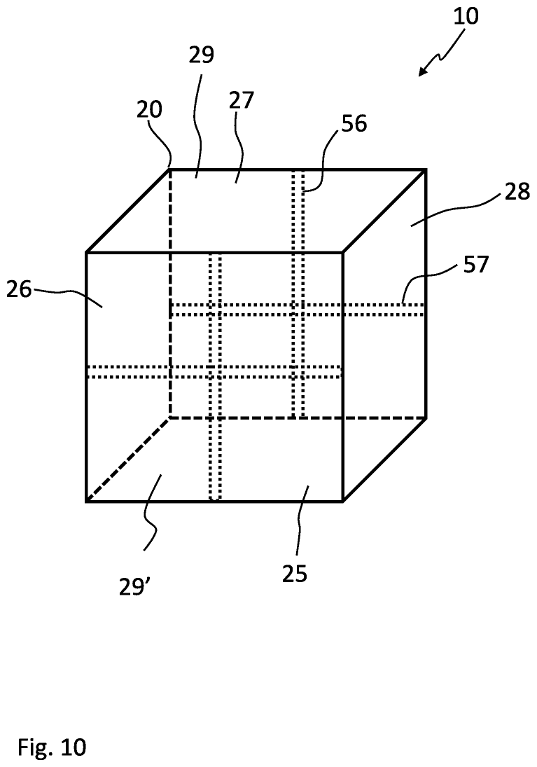

FIG. 10 shows a further embodiment, in which reinforcement members 56, 57 are provided to the inner surface of the casing walls 29, 29′.

The reinforcement members 56, 57 provided to casing walls 29, 29′ extend preferably between casing walls 26, 27 adjacent to the casing wall 29, 29′ with the reinforcement members 56, 57.

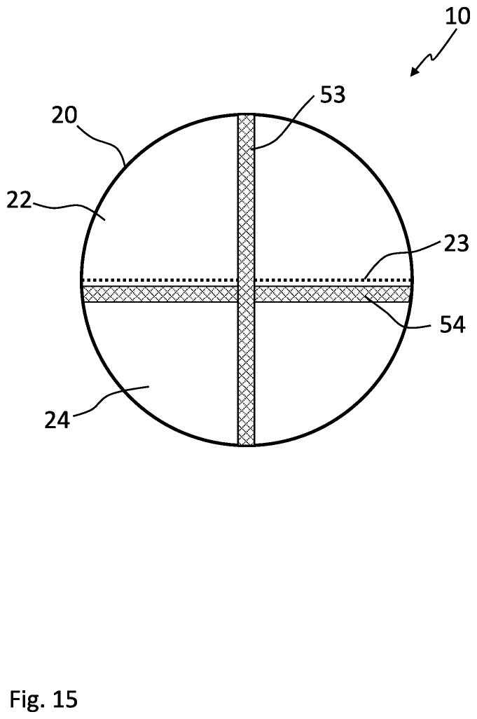

FIG. 15 shows an alternative embodiment in which the sonde casing 20 comprises spherical shape. This embodiment corresponds the embodiment of FIG. 8. The sonde casing 20 comprises the spherical shape with first and second reinforcement members 54, 53. The first and second reinforcement members 54, 53 are perpendicular to each other and extend through the inner space of the sonde casing 20. Also in this embodiment, the sonde casing 20 may comprise third reinforcement members (not shown) extending perpendicularly to the first and reinforcement members 54, 53.

The reinforcement members or plates 54, 53 may be arranged to locations of the symmetry planes, as in FIG. 16. In FIG. 15 the reinforcement members 54, 53 are provided as reinforcement plates.

Further, it should be noted that the reinforcement members or plates 54, 53 may also form the support structure 50 for the circuit board 30 or flexible circuit board 30.

The reinforcement members 54, 53, 55, 56, 57 may be made of same material as the sonde casing 20 or from the same material as the support structure 50. Alternatively, the reinforcement members 54, 53, 55, 56, 57 may be made of different material than the sonde casing 20 and the support structure 50.

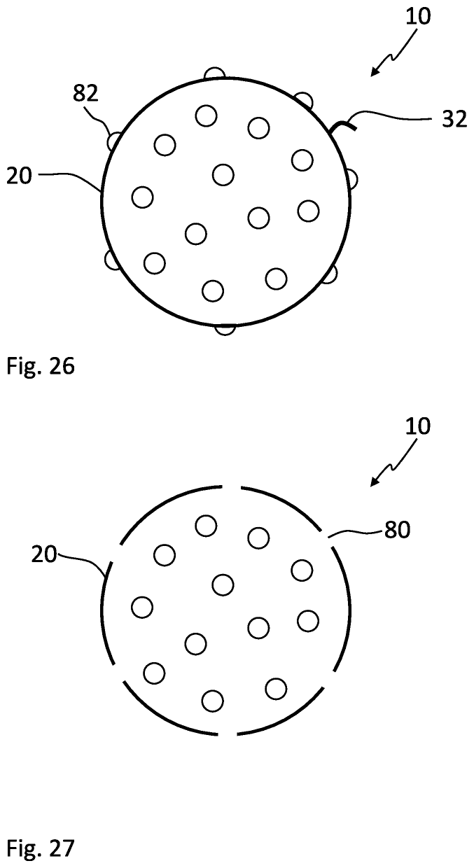

FIG. 26 further shows one embodiment of the sonde casing 20. As shown in FIG. 26, the outer surface of the sonde casing 20 or the casing walls are provided with protrusions 82 extending outwards from the outer surface of the sonde casing 20. The protrusions increase the drag surface and also cause turbulent streams around the self-sustaining sonde 10 such that the drag force is increased and the terminal velocity of the aerological sonde 10 decreased.

The protrusions 82 may be integral part of the sonde casing 20. Alternatively, the protrusions are attached to the outer surface of the sonde casing 20.

The protrusions 82 may be made of same material as the sonde casing 20 or from the same material as the support structure 50. Alternatively, the protrusions 82 may be made of different material than the sonde casing 20 and the support structure 50. The protrusions 82 may be attached to the sonde casing 20 or the outer surface thereof or formed from the material of the sonde casing 20.

In some embodiments, the meteorological measurement element 60 or at least part, for example a meteorological sensor part, of it is provided outside the sonde casing 20. The meteorological measurement element 60 or the meteorological sensor part thereof may extend from the inside of the sonde casing 20 to the outside of the sonde casing 20. Alternatively, the meteorological measurement element 60 or the meteorological sensor part thereof may be arranged outside the sonde casing 20.

The meteorological sensor part may be a sensor tip or sensor strip.

In some embodiments, the meteorological measurement element 60 or the meteorological sensor part extends outwards form the outer surface of the sonde casing 20. In this embodiment, the meteorological measurement element 60 or the meteorological sensor part thereof forms at least one of the protrusions 82.

In another embodiment, the meteorological measurement element 60 or the meteorological sensor part thereof is arranged against the outer surface of the sonde casing. In this embodiment, the meteorological measurement element 60 or the meteorological sensor part thereof forms part of the outer surface of the sonde casing 20.

In further alternative embodiment, an antenna or part of the antenna 32 may extend outwards form the outer surface of the sonde casing 20, as shown in FIG. 26. The antenna or part of the antenna may be FM antenna, or any other antenna provided to the measurement unit 12.

Accordingly in the above embodiments, the drag surface of the aerological sonde is formed by the outer casing surface and the meteorological measurement element and/or the meteorological sensor part and/or the antenna extending form the outer casing surface.

FIG. 27 shows an embodiment, in which the sonde casing 20 comprises openings 80 extending through the casing walls on the sonde casing 20. There may be one or more openings, or two or more openings 80 in the sonde casing 20. Thus, the openings 82 extend from the outer surface of the sonde casing 20 to the inner surface of the sonde casing 20.

The openings 80 enable air flow inside the sonde casing 20 and thus the drag force subjected to the aerological sonde 10 is increased. The openings 80 and the sonde casing 20 together for parachute-like structure as the air flows may enter inside the sonde casing 20.

The size and shape of the openings 80 may vary depending on different embodiments.

In this embodiment the measurement unit 12 is preferably encapsulated with protective material for protecting the measurement unit 12 and the components thereof from the air flows.

The sonde casing 20 may in some embodiments comprise both the openings 80 and the protrusions 82.

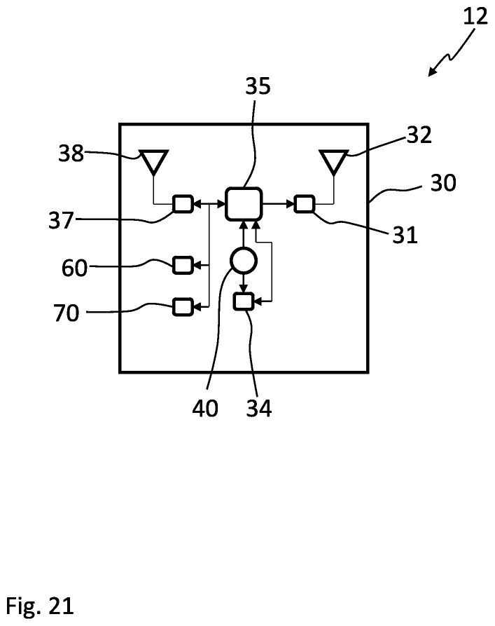

FIG. 21 shows one embodiment of the measurement unit 12 of the self-sustaining aerological sonde. 10.

The measurement unit comprises a power source 40 which provides electrical power to the measurement unit 12 and components thereof.

In one embodiment, the measurement unit 12 comprises a power source or a battery or an accumulator having weight equal to or less than 2 g. Battery is the heaviest component in the measurement unit 12, and thus a light-weight battery having weight 2 g or less is essential for achieving the terminal velocity of 3 m/s or under.

In some embodiments, the battery 40 is a Lithium-Polymer battery or a semi-solid Lithium metal battery or a foam battery with porous copper structure.

The measurement unit 12 further comprises power management circuitry 34 connected to the battery 40 and a microcontroller 35. The power management circuitry 34 controls power usage of the measurement unit 12 and components thereof.

In one embodiment, the measurement unit 12 comprises one or more of the following a pressure sensor, a humidity sensor, and a temperature sensor 70.

In preferred embodiments, the measurement unit 12 comprises meteorological sensor 60 or meteorological measurement element 60 comprising at least two of the pressure sensor, the humidity sensor, and the temperature sensor in one component. This provides decreased weight for the meteorological sensor components 60.

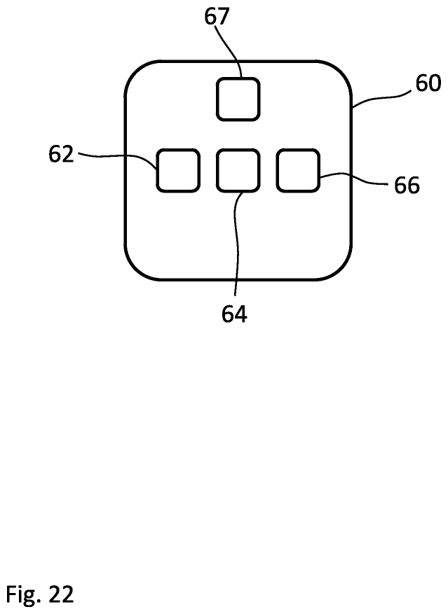

FIG. 22 shows an embodiment in which the meteorological sensor 60 comprises at least two of the pressure sensor 62, the humidity sensor 64, and the temperature sensor 66 in one component.

The pressure sensor 2, humidity sensor 64 and the temperature sensor may be any known kind sensors.

In some embodiments, the measurement unit 12 or the meteorological measurement element 60 further comprises a magnetometer 67. The magnetometer is arranged to measure changes in magnetic field in the atmosphere, for example caused by thunders. The magnetometer 67 may be any known kind of magnetometer, preferably a very light-weight magnetometer.

In some embodiment, the measurement unit 12 may also comprise one or more gas sensors (not shown) for measuring one or more different gases in the atmosphere during migration. The gas sensor may be for example an ozone sensor or nitrogen oxide (NOX) sensor.

The measurement unit 12 further comprises a global navigation satellite system element comprising a global navigation satellite system receiver 37 and global navigation satellite system antenna 38.

The global navigation satellite system receiver 37 comprises a global positioning system (GPS) receiver. Alternatively, global navigation satellite system receiver 37 comprises a GPS, Galileo, Beidou and/or Glonass receiver.

The global navigation satellite system antenna 38 is provided as linearly polarized antenna.

The global navigation satellite system antenna 38 is provided to the circuit board 30 or to the flexible circuit board 30 as circuit board antenna.

Alternatively, the global navigation satellite system antenna 38 is provided to the circuit board 30 or to the flexible circuit board 30 as a linearly polarized chip antenna. This may also be a circuit board antenna.

The circuit board antenna or chip antenna 38 may be linearly polarized antennas.

The circuit board antenna or chip antenna 38 is preferable due to their light-weight structure of these types of antennas.

The global navigation satellite system element 36, 38 is utilized for measuring location data of the aerological sonde 10.

The measurement unit 12 further comprises a telemetry element 31. The telemetry element 31 is arranged to transmit measurement results from the aerological sonde 10 to a remote location or system. Thus, in some embodiments the telemetry element 31 is arranged transmit measurement results of the turbulence sensor 70 and possible meteorological measurement element 60.

In one embodiment the telemetry element 31 is a frequency modulation (FM) element 31 comprising FM link and FM transmitter. An FM antenna 32 is connected to the FM element 31.

The FM antenna 32 is provided to the circuit board 30 or to the flexible circuit board 30 as circuit board antenna.

The FM antenna 32 may be a folded dipole antenna provided to the circuit board 30.

Alternatively, the FM antenna 32 may be wire antenna.

In another embodiment, the telemetry element 31 is a wifi element or like communication element.

The circuit board antenna, folded dipole antenna or the wire antenna 32 are preferable due to their light-weight structure.

The measurement unit 12 of the aerological sonde 10 comprises a turbulence sensor 70 arranged to measure turbulence in the cyclonic storm.

In one embodiment, the turbulence sensor 70 comprises a gyroscopic sensor 74 arranged to measure orientation of the self-sustaining aerological sonde, as shown in FIG. 25.

The gyroscopic sensor 74 is arranged to measure changes in orientation of the aerological sonde 10 or angular velocity of the aerological sonde 10 in relation to at least one rotation axis X, Y or Z of the aerological sonde 10. Thus, the gyroscopic 72 sensor may measure spinning or turning of the aerological sonde 10 in the cyclonic storm due to the turbulent streams or turbulent flows in the cyclonic storm.

In one embodiment, the gyroscopic sensor 74 is a multi-dimensional gyroscopic sensor. In this embodiment, the gyroscopic sensor 74 is constructed and arranged to measure orientation or angular velocity of the aerological sonde in relation to two or more rotation axes, or three rotation axes X, Y and Z. The multi-dimensional gyroscopic sensor 74 has a good effective weight as the one component is able to measure turbulence in the cyclonic storm and spinning of the aerological sonde 10 around two or more rotation axes X, Y and Z.

In another embodiment, the gyroscopic sensor is a 3-dimensional gyroscopic sensor 74, as shown in FIG. 25. In this embodiment, the gyroscopic sensor 74 is constructed and arranged to measure orientation or angular velocity of the aerological sonde 10 in relation to three rotation axes X, Y and Z. Preferably, the three rotation axes X, Y and Z extend perpendicularly to each other.

Alternatively, the gyroscopic sensor 74 comprises one or more one-dimensional gyroscopic sensors. In this embodiment, the turbulence sensor 70 comprises one or more separate one-dimensional gyroscopic sensors 74 each of which is constructed and arranged to measure orientation or angular velocity of the aerological sonde 10 in relation to one rotation axis.

The gyroscopic sensor 74 is a vibrating structure gyroscopic sensor.

The vibrating gyroscopic sensor 74 may be a microelectromechanical gyroscopic sensor, MEMS gyroscopic sensor.

In one embodiment, the turbulence sensor 70 comprises an accelerometer 72 arranged to measure change of rate of velocity of the self-sustaining aerological sonde 10. The accelerometer 72 measures changes in moving velocity of the aerological sonde 10.

In one embodiment, the accelerometer 72 is a multi-dimensional accelerometer. In this embodiment, the accelerometer 72 is constructed and arranged to measure acceleration of the aerological sonde in direction of two or more velocity axes X, Y and Z. Preferably, the two or more velocity axes X, Y and Z extend perpendicularly to each other.

In another embodiment, the accelerometer 72 is a 3-dimensional accelerometer, as shown in FIG. 24. In this embodiment, the accelerometer 72 is constructed and arranged to measure changes in movement velocity of the aerological sonde 10 in relation to three velocity axes X, Y and Z. Preferably, the three velocity axes X, Y and Z extend perpendicularly to each other.

In a further embodiment, the accelerometer 72 comprises one or more one-dimensional accelerometers. In this embodiment, the accelerometer 72 comprises one or more separate one-dimensional accelerometers each of which is constructed and arranged to measure change of velocity of the aerological sonde in direction of one velocity axis X, Y or Z.

The accelerometer is a microelectromechanical accelerometer, MEMS accelerometer.

The accelerometer 72 provides acceleration measurement values which may further ris used for calculating jerk and jounce. Jerk is the change of rate of acceleration and jounce is change of rate of jerk.

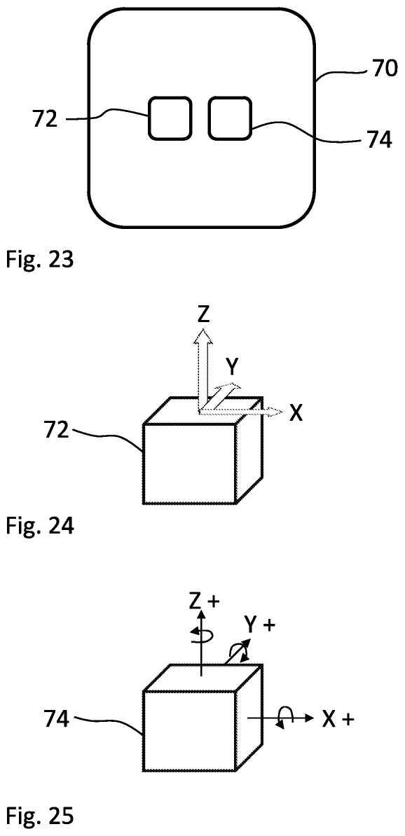

Preferably, the gyroscopic sensor 74 and the accelerometer 72 are provided as a single component 70, as shown in FIG. 23. This provides light weight and efficient utilization of space in the aerological sonde.

In another embodiment, the gyroscopic sensor 74 and the accelerometer 72 are provided as separate components.

In one embodiment, the turbulence sensor 70, or the accelerometer 72 and/or gyroscopic sensor 74 thereof, is secured to the sonde casing 10. The turbulence sensor 70, or the accelerometer 72 and/or gyroscopic sensor 74 thereof, may be provided to the circuit board 30 and the circuit board 30 is secured or attached to the to the sonde casing 20 or to the inner surface of the sonde casing 20 for securing the turbulence sensor 70 to the sonde casing 20.

The invention has been described above with reference to the examples shown in the figures. However, the invention is in no way restricted to the above examples but may vary within the scope of the claims.

1.-18. (canceled)

19. An aerological sonde for measuring meteorological conditions in the atmosphere, the aerological sonde comprising a sonde casing having an outer casing surface and a measurement unit arranged inside the sonde casing, the outer casing surface of the sonde casing is arranged to form a drag surface of the aerological sonde such that a self-sustaining aerological sonde is formed characterized in that the self-sustaining aerological sonde has a terminal velocity, the terminal velocity of the self-sustaining sonde being determined by the outer casing surface of the sonde casing and the weight of the self-sustaining aerological sonde, the terminal velocity being equal to or less than 5 m/s.

20. The aerological sonde according to claim 19, wherein the outer casing surface of the sonde casing is arranged to form a sole drag surface of the aerological sonde such that a self-sustaining aerological sonde is formed.

21. The aerological sonde according to claim 19, wherein the terminal velocity is equal to or less than 4 m/s.

22. The aerological sonde according claim 19, wherein at least one of:
the sonde casing is made of material having material density equal to or less than 0.2 g/cm³;
the sonde casing is made of material having material density equal to or less than 0.15 g/cm³; and/or the sonde casing is made of material having material density equal to or less than 0.1 g/cm³.

23. The aerological sonde according to claim 22, wherein the sonde casing comprises at least one of:
aerogel material;
foam material; and/or
polystyrene.

24. The aerological sonde according to claim 19, wherein the weight of the sonde casing is equal to or less than 2.5 g.

25. The aerological sonde according to claim 19, wherein the outer casing surface of the sonde casing is arranged to define a shape of the aerological sonde having a drag coefficient equal to or greater than 0.4 for Reynolds number 10⁴.

26. The aerological sonde according to claim 19, wherein one of:
the self-sustaining aerological sonde having a spherical or elliptical shape defined by the outer casing surface of the sonde casing;
the self-sustaining aerological sonde having a cubical shape defined by the outer casing surface of the sonde casing;
the self-sustaining aerological sonde having a cubical shape with rounded corners defined by the outer casing surface of the sonde casing; and
the self-sustaining aerological sonde having a polyhedron shape or regular polyhedron shape defined by the outer casing surface of the sonde casing.

27. The aerological sonde according to claim 19, wherein one of:
the sonde casing comprises a first symmetry plane (B) and a second symmetry plane (C), the first symmetry plane (B) and the second symmetry plane (C) extending perpendicularly to each other; and
the sonde casing comprises a first symmetry plane (B), a second symmetry plane (C) and a third symmetry plane, the first symmetry plane, the second symmetry plane (C) and the third symmetry plane extending perpendicularly to each other.

28. The aerological sonde according to claim 19, wherein at least one of:
the measurement unit comprises a printed circuit board; and/or
the measurement unit comprises a printed circuit board, the printed circuit board is a flexible printed circuit board.

29. The aerological sonde according to claim 28, wherein the self-sustaining aerological sonde comprises a support structure for the flexible printed circuit board, the flexible printed circuit board being supported on the support structure.

30. The aerological sonde according to claim 29, wherein at least one of:
the support structure is made of material having honeycomb structure;
the support structure is made of aerogel material;
the support structure is made of paper-based material; and/or
the support structure is made of foam material.

31. The aerological sonde according to claim 28, wherein the flexible printed circuit board is supported on or to inner surface of the sonde casing.

32. The aerological sonde according to claim 28, wherein at least one of:
the measurement unit comprises a global navigation satellite system antenna provided to the circuit board or to the flexible printed circuit board as circuit board antenna;
the measurement unit comprises a frequency modulation antenna provided to the circuit board or to the flexible printed circuit board as circuit board antenna; and/or
the measurement unit comprises a global navigation satellite system antenna and a frequency modulation antenna provided to the circuit board or to the flexible printed circuit board as circuit board antennas.

33. The aerological sonde according to claim 19, wherein the measurement unit comprises a battery having weight equal to or less than 2 g.

34. The aerological sonde according to claim 19, wherein the outer casing surface of the sonde casing comprises one or more protrusions protruding outwards from the outer casing surface of the sonde casing increasing the drag coefficient.

35. The aerological sonde according to claim 19, wherein the sonde casing comprises two or more openings provided to the sonde casing, the two or more openings extending through the casing walls of the sonde casing for enabling air flow inside the sonde casing.

36. The aerological sonde according to claim 19, wherein total weight of the self-sustaining aerological sonde is equal to or less than 6 g, or preferably equal to or less than 5 g.
